(19) United States
(12) Patent Application Publication
(10) Pub. No.: US 2016/0250669 A1
(43) Pub. Date: Sep. 1, 2016

(54) WATER AND DEBRIS RECOVERY SYSTEM

(71) Applicant: Waterblasting, LLC, Stuart, FL (US)

(72) Inventor: James P. Crocker, Stuart, FL (US)

(21) Appl. No.: 15/017,267

(22) Filed: Feb. 5, 2016

Related U.S. Application Data
(60) Provisional application No. 62/113,194, filed on Feb. 6, 2015.

(51) Int. Cl. B08B 3/02; B08B 13/00

(52) U.S. Cl. CPC B08B 3/02; B08B 13/00

(57) ABSTRACT

The present system relates to a water and debris recovery system for a water blasting device or water demolition system suitable for mounting upon the frame of a mobile vehicle for easy transport and use. The system includes a liquid reservoir connected to a high pressure fluid pump for directing ultra-high pressure water through a blast head to remove the coatings or markings from a surface. The blast head includes a shroud which surrounds the blasting area to at least partially contain the water and debris dislodged from the surface. A centrifugal debris conveyor is secured to the shroud with the vacuum passing through the centrifugal debris conveyor where it is accelerated for transfer into an open top tank.

### RELATED APPLICATIONS

In accordance with 37 C.F.R 1.76, a claim of priority is included in an Application Data Sheet filed concurrently herewith. Accordingly, under 35 U.S.C. §119(e), 120, 121, and/or 365(c) the present invention claims priority of U.S. patent application Ser. No. 62/113,194, entitled “WATER AND DEBRIS RECOVERY SYSTEM”, filed on Feb. 6, 2015. The contents of each of the above referenced applications are herein incorporated by reference in its entirety.

### FIELD OF THE INVENTION

This invention relates to the field of high pressure water cleaning devices for highways, airport runways, parking decks, subway stations, ships and other hard surfaces.

### BACKGROUND OF THE INVENTION

Surface cleaning apparatus, such as pressure washers, are useful for cleaning a variety of objects. Such devices require a clean supply of water for proper operation, but create wastewater by entraining solids from the cleaned surface into the used source water. Although there are many types of pressure washing systems, a typical system utilizes an engine that powers a pump. The inlet side of the pump is connected to a low pressure water source such as a tank or a municipal water supply, while the high pressure side of the pump is connected to a high pressure hose and wand for controlling the flow of high pressure water generated by the pump. The high pressure water is directed at a surface to dislodge dirt, paint and the like, and the water is generally allowed to drain into the storm sewer.

Ultra-high pressure washers, supplying more than 25,000 P.S.I. are also known. These systems include a large engine, typically diesel, which operates a large multi-cylinder pump to generate high volumes of water at ultra-high pressures. The ultra-high pressure water is directed through piping and/or hoses to various types of blast heads suitable for controlling the flow and direction of the ultra-high pressure water. One particular use for ultra-high pressure water devices is the removal of stripes or other markings from road surfaces. When polymers such as paint or plastic are used for roadway marking, the surface of the pavement is penetrated from ⅛-⅜ inch; whereby water blasting is the only known method of removing the stripe material from below the surface without removing a portion of the roadway surface. Ultra-high pressure water washers are also utilized for removing paint from ships, cleaning industrial facilities, removing graffiti, removing rubber from aircraft runways and demolition.

One problem associated with both low and ultra-high pressure water cleaning equipment is recovering the dirty water and debris while maintaining continuous operation of the system. Dirt and dirty airborne contaminated water causes numerous problems with vacuum recovery systems provided on water cleaning equipment such as excessive vacuum pump wear, clogged air filters and the like. Water blasting equipment typically utilizes roots type vacuum pumps. Roots type vacuum pumps utilize two synchronously counter-rotating rotors having a figure eight configuration that are counter rotated within a housing while a very small gap is maintained between the rotors. Thus, the roots vacuum pump is highly susceptible to dirt impingement and grinding between the rotors degrading the system. To reduce wear and tear from dirt, water blasting systems typically utilize a cyclone or RotoClone to collect dust and dirty airborne water before passing the air through the roots pump. Paper filters are also utilized as a secondary filter system because the roots pumps are so sensitive to dirt intrusion. These systems add significant weight to the truck and require expensive and constant maintenance to maintain their effectiveness.

In addition vacuum recovery systems require high vacuum and large vacuum tanks causing very high loads on the walls of the tanks due to the large internal surface area requiring the tank walls to be very thick to withstand the loads. The heavy tanks add significant weight to the assembly reducing the capacity of the vehicle or requiring additional axles to haul the loads while meeting load limit requirements.

Therefore, what is needed in the art is a system for recovering water and debris from a water blasting or water demolition project that does not require a roots type vacuum pump for collecting water and debris from the blast head. The system should utilize a vacuum system suitable to pass all of the water and debris through the vacuum system for recovery. The vacuum system should be suitable to operate with an open or closed tank. The recovery system should be compact for mounting on various types of vehicles, trailer and skids.

### SUMMARY OF THE INVENTION

Briefly, disclosed is a water and debris recovery system for a water blasting device or water demolition system; the system being suitable for mounting upon the frame of a mobile vehicle for easy transport and use. The system includes a liquid reservoir connected to a high pressure fluid pump for directing ultra-high pressure water through a blast head to remove the coatings or markings from a surface. The blast head is mounted on a vehicle and includes a shroud which surrounds the blasting area to at least partially contain the water and debris dislodged from the surface. The inlet to a centrifugal debris conveyor is secured to the shroud, with the vacuum passing through a centrifugal debris conveyor where it is discharged into a holding tank allowing the water and debris to settle to the bottom tank while the air is allowed to vent to the atmosphere.

Accordingly, it is an objective of the instant invention to provide a water and debris recovery system which can be readily transported.

It is a further objective of the instant invention to provide a water and debris recovery system that does not need a vacuum tank for the recovery and storage of the recovered water and debris.

It is yet another objective of the instant invention to provide a unique vacuum pump in the form of a centrifugal debris conveyor suitable for transferring water and debris from the blast head to a non-vacuum holding tank.

It is still another objective of the instant invention to provide a vacuum pump in the form of a centrifugal debris conveyor suitable for transfer of sticky polymeric materials through the centrifugal debris conveyor.

Yet another objective of the invention is to provide a centrifugal debris conveyor having removable and replaceable blades.

Still yet another objective of the invention is to provide a centrifugal debris conveyor that can be converted from straight blades to curved blades and from curved blades to straight blades.

An even further objective of the present invention is to provide a centrifugal debris conveyor that includes hardened blades for increased wear.

Yet a further objective of the present invention is to provide a centrifugal debris conveyor that includes a lined enclosure, whereby the lining may be changed for increased wear.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic representation of the water and debris recovery system of the present invention, illustrated with a rotary valve type pump;

FIG. 2 is a schematic representation of various embodiments of the centrifugal debris conveyor suitable for use with the present system;

FIG. 3 is a isometric view of one embodiment of the centrifugal debris conveyor, illustrated with removable and replaceable blades;

FIG. 4 is a isometric view of one embodiment of the centrifugal debris conveyor, illustrated with removable and replaceable blades;

FIG. 5 is a partial isometric view of one embodiment of the centrifugal debris conveyor, illustrating key slots which locate the removable and replaceable blades;

FIG. 6 is an isometric view illustrating a shroud for the centrifugal debris conveyor having a removable and replaceable wear liner.

### DETAILED DESCRIPTION OF THE INVENTION

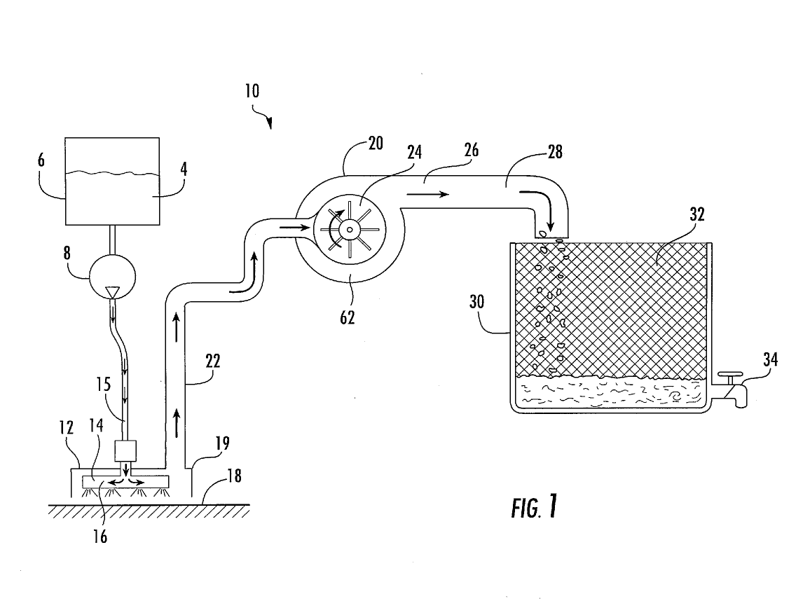

Referring to FIG. 1, one embodiment of the water and debris recovery system 10 is illustrated. The system begins at the blast head 12 where fresh water 4 from holding tank 6 is directed through ultra-high pressure pump 8 to create ultra-high pressure water 15 which is directed through nozzles 14 secured to rotationally mounted spray bar 16. The ultra-high pressure water 15 impinges on the surface 18, removing surface markings as well as any loose debris which is trapped within the shroud 19. The centrifugal debris conveyor 20 provides a negative air flow through the shroud 19 to draw the water and debris into tube 22. The centrifugal debris conveyor 20 is preferably a radial blade centrifugal debris conveyor, however, any forward curved centrifugal debris conveyor 40 or backward curved centrifugal debris conveyor 42 suitable for creating sufficient vacuum, e.g. negative air pressure, to transfer the water and debris is suitable. It should be noted that additional vacuum may be developed by the rotating spray bar 16 which may include airfoils or the like which develop negative air pressure during rotation of the spray bar for assisting the centrifugal debris conveyor 20. Water and debris from tube 22 is directed into the intake port 24 of the centrifugal debris conveyor 20, which accelerates the water and debris for ejection through outlet port 26. The water and debris are directed at high speeds through discharge tube 28 to the debris tank. The debris tank 30 is preferably an open top, non-vacuum type, tank that may be constructed from any material suitable in the art for constructing tanks. The system may be mounted on a vehicle, skid, trailer or any other suitable means for supporting the system. The debris tank 30 may also include a filter bag 32 or the like suitably secured within the debris tank 30 to allow the solid debris to be dewatered through a valve 34. The debris tank 30 may also include tilting or other dumping mechanisms (not shown) which allow the tank to be easily emptied without departing from the scope of the invention.

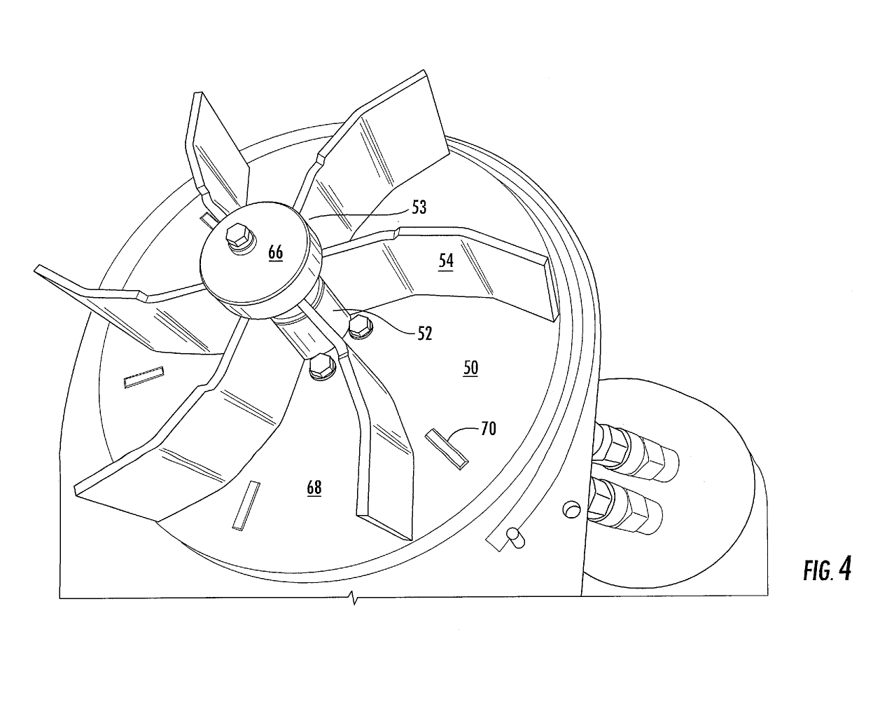

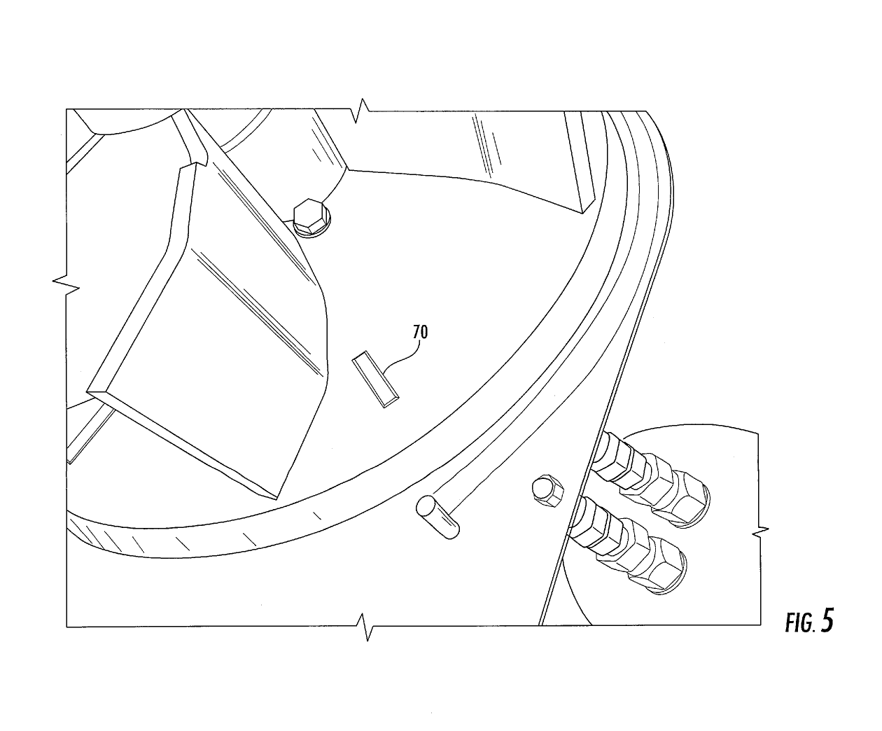

Referring to FIGS. 1 through 6, various views of preferred embodiments of the centrifugal debris conveyor 20 are illustrated. The centrifugal debris conveyor 20 includes a debris conveyor wheel 50 which includes a hub 52 onto which a number of blades 54 are attached and a shroud 62. The blades may include various arrangements including forward curved 56, backward curved 58 and radial 60. In other embodiments, the blades may include airfoil type cross-sections and the like to improve airflow and thus vacuum. The shroud 62 is generally constructed and arranged to direct the airflow into the debris conveyor wheel 50 so that it can be accelerated and ejected through the outlet port 26. A motor (not shown) is provided for rotation of the debris conveyor wheel 50. The motor is preferably a fluid drive motor having suitable size to rotate the debris conveyor wheel 50 at a speed suitable to draw the airstream from the blast head while loaded with debris and fluid. In at least one embodiment, the motor is a hydraulic motor that includes a flow control or the like to allow control of the speed of rotation of the debris conveyor wheel 50. In this manner, the operator can cause the debris conveyor wheel 50 to operate at a sufficient speed to keep debris from over accumulating in the blast head. It should also be noted that while a hydraulic motor is illustrated, an air, electric, gas or diesel engine or motor may be substituted without departing from the scope of the invention.

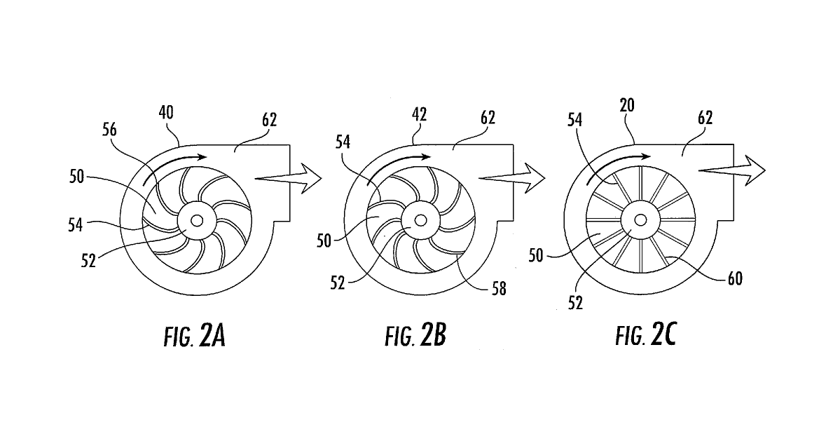

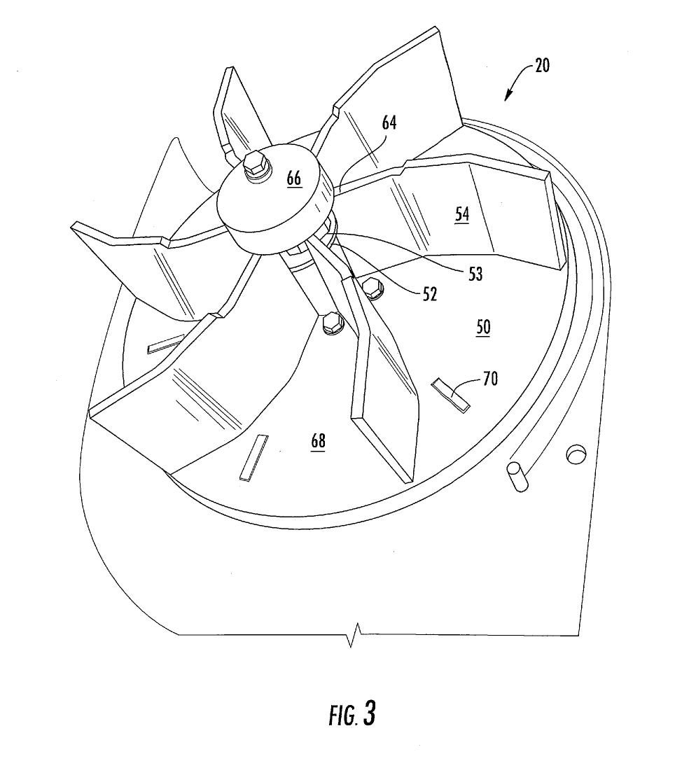

Referring to FIGS. 3 through 6 a preferred embodiment of the centrifugal debris conveyor 20 is illustrated. In this embodiment, the conveyor wheel 50 is constructed and arranged to include removable and replaceable blades 54. In order to facilitate the removable and replaceable blades 54 the hub 52 is provided with slots 53 sized to accept the base end 64 of the blade 54 while a pressure plate 66 holds the base end in position. The wheel plate 68 is provided with notches 70 which also cooperate with the blades 54 to align and hold the blades in position. Notches are provided for blades having the forward curve, backward curve and radial shapes as shown in FIG. 2. This construction allows the user to switch blade types for tuning and adjusting the amount of vacuum provided to the blasting head 12. This construction also allows the user to use hardened blades or blades made from materials that are different than those of the wheel plate and hub for desired wear characteristics.

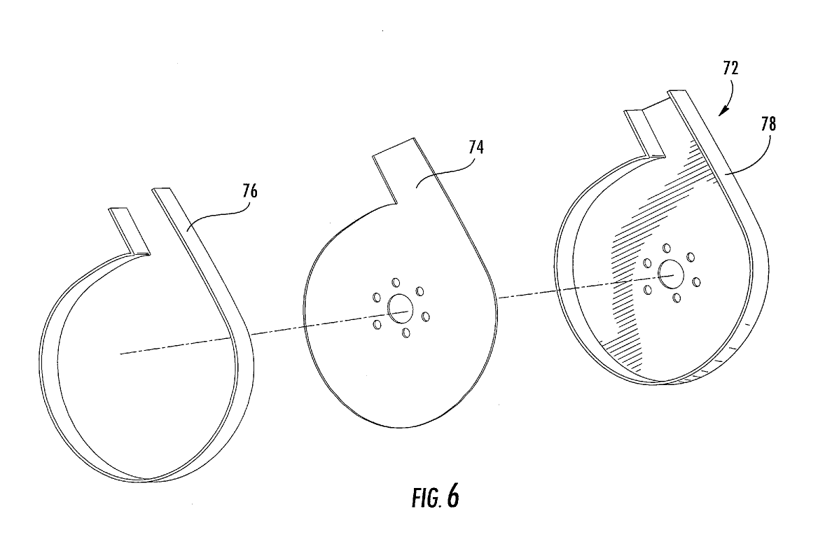

Referring to FIG. 6, a preferred embodiment of the debris conveyor shroud 72 is illustrated. The debris conveyor shroud functions to enclose the debris conveyor and direct the water and debris in the proper direction by guiding the air flow created by the debris conveyor. Thus, the debris conveyor shroud is subject to high wear from the high speed particles of debris and water moving through the shroud. Therefore, the debris conveyor shroud is provided with wear plates 74 and 76 which fit within the shroud shell 78. Thus, the shroud shell 78 can be constructed from lower cost materials while the wear plates 74 and 76 can be higher wear or hardened materials which may include, but should not be limited to, metals and polymers. In a most preferred embodiment, the wear plates 74 and 76 are shaped to fit snugly within the shell. However, the wear plates could include alternative shapes that are constructed to improve wear or air flow characteristics within the debris conveyor without departing from the scope of the invention.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A water and debris recovery system comprising:
a blast head for discharging high pressure water for impingement against a surface;
a shroud secured around said blast head for containing said high pressure water, said shroud including a conduit which provides fluid connection to a centrifugal debris conveyor, said centrifugal debris conveyor having a debris conveyor wheel secured for rotation within a debris conveyor shroud, said debris conveyor wheel including at least one blade secured to said debris conveyor wheel to be rotated therewith, said centrifugal debris conveyor fluidly connected to a non-vacuum tank, whereby rotation of said debris conveyor wheel creates a low pressure area inside said blast head shroud so that water and debris from said blast head is drawn into said centrifugal conveyor and accelerated by said conveyor wheel and directed to said non-vacuum tank.

2. The water and debris recovery system of claim 1 wherein said debris conveyor wheel includes a plurality of said blades, said water and debris from said blast head entering said debris conveyor wheel near an axis of rotation of said debris conveyor wheel and exiting said debris conveyor wheel at a point near the outer diameter of said debris conveyor wheel.

3. The water and debris recovery system of claim 2 wherein said debris conveyor wheel includes a wheel plate to which said blades are removably secured, whereby said blades are removable and replaceable.

4. The water and debris recovery system of claim 3 wherein said debris conveyor wheel plate includes a hub positioned at the axis of rotation of said debris conveyor wheel, said hub being constructed and arranged to fit over a base portion of said blades for securing said blades to said debris conveyor wheel.

5. The water and debris recovery system of claim 4 wherein said hub includes slots sized to accept a base end of each said blade while a pressure plate holds said base end in each respective slot.

6. The water and debris recovery system of claim 3 wherein said wheel plate includes notches which cooperate with tabs extending outwardly from a side of said blades for aligning and positioning said blades.

7. The water and debris recovery system of claim 6 wherein said wheel plate includes notches for blades having a forward curve, a backward curve and radial blades, whereby a user may select and install a blade to provide said rotary debris conveyor with a desired property of moving debris.

8. The water and debris recovery system of claim 2 wherein said debris conveyor shroud functions to enclose said conveyor wheel to guide the air flow created by said conveyor wheel.

9. The water and debris recovery system of claim 8 wherein said debris conveyor shroud includes a removable and replaceable liner, whereby said liner can be replaced when worn.

10. The water and debris recovery system of claim 8 wherein said liner for said debris conveyor shroud includes a shape that is substantially conjugate to said debris conveyor shroud.

11. The water and debris recovery system of claim 8 wherein said liner for said debris conveyor shroud includes a shape that is different when compared to said debris conveyor shroud, said liner controlling the flow of air through said debris conveyor.

12. A centrifugal debris conveyor comprising:
a conveyor wheel secured for rotation within a debris conveyor shroud, a fluid drive motor secured to said conveyor wheel for providing rotation thereto, said debris conveyor wheel including at least one blade secured thereto for creating airflow when rotated, said at least one blade being removable and replaceable.

13. The centrifugal debris conveyor of claim 12 wherein said conveyor wheel includes a debris conveyor wheel plate, said debris conveyor wheel plate including a hub positioned at the axis of rotation of said debris conveyor wheel, said hub being constructed and arranged to fit over a base portion of said blades for securing said at least one blade to said debris conveyor wheel, said hub including slots sized to accept a base end of each said at least one blade while a pressure plate holds said base end in each respective slot.

14. The centrifugal debris conveyor of claim 13 wherein said wheel plate includes notches which cooperate with tabs extending outwardly from a side of said at least one blade for aligning and positioning said at least one blade.

15. The centrifugal debris conveyor of claim 14 wherein said wheel plate includes notches for said at least one blade having a forward curve, a backward curve or a radial blade, whereby a user may select and install at least one blade to provide said rotary debris conveyor with a desired property of moving debris.

16. The centrifugal debris conveyor of claim 12 wherein said debris conveyor shroud functions to enclose said conveyor wheel to guide the air flow created by said conveyor wheel.

17. The centrifugal debris conveyor of claim 16 wherein said debris conveyor shroud includes a removable and replaceable liner, whereby said liner can be replaced when worn.

18. The centrifugal debris conveyor of claim 17 wherein said liner for said debris conveyor shroud includes a shape that is substantially conjugate to said debris conveyor shroud.

19. The centrifugal debris conveyor of claim 17 wherein said liner for said debris conveyor shroud includes a shape that is different when compared to said debris conveyor shroud, said liner controlling the flow of air through said debris conveyor.
